(19) United States
(12) Patent Application Publication
(10) Pub. No.: US 2008/0094361 A1
(43) Pub. Date: Apr. 24, 2008

(54) Control Apparatus for Enabling Computer Peripheral to be Controlled by Keyboard Indication Commands

(75) Inventor: Ching-Wei Cheng, Keelung City (TW)

Correspondence Address: WPAT, PC, 7225 BEVERLY ST., ANNANDALE, VA, 22003, US

(73) Assignee: ACTION STAR ENTERPRISE CO., LTD., Taipei County (TW)

(21) Appl. No.: 11/552,965

(22) Filed: Oct. 25, 2006

(30) Foreign Application Priority Data
Oct. 20, 2006 (TW) 095218526

(51) Int. Cl. G09G 5/00

(52) U.S. Cl. 345/168

(57) ABSTRACT

A control apparatus for enabling computer peripherals to be controlled by keyboard indication commands is disclosed, which is substantially a control box connected to a computer and a keyboard respectively by interfaces thereof, and is comprised of: a micro control unit (MCU), capable of issuing an activating signal while receiving a keyboard indication command from the keyboard; and a computer peripheral, capable of being activated/deactivated by the activating signal.

### FIELD OF THE INVENTION

The present invention relates to a control apparatus for enabling computer peripherals to be controlled by keyboard indication commands, and more particularly, to a control box connected to a computer and a keyboard respectively by interfaces thereof, so that it is capable of enabling a micro control unit (MCU) to issue an activating signal to a computer peripheral for controlling the same after a keyboard indication command issued from the keyboard is received by the MCU.

### BACKGROUND OF THE INVENTION

Keyboard and mouse are the two most common input devices for computers. However, between the two input devices, keyboard is only used for inputting characters, numerals or symbols, that it has no other function. Therefore, it is intended in the invention to use indication light commands of keyboards as control signals for controlling computer peripherals, so that the usage of keyboards can be broadened and thus the sales thereof can be enhanced.

### SUMMARY OF THE INVENTION

In view of the disadvantages of prior art, the primary object of the present invention is to provide a control apparatus for enabling computer peripherals to be controlled by keyboard indication commands, that enables a keyboard to be used not only as a device for inputting characters, numerals or symbols, but also as a control box, connected to a computer and a keyboard respectively by interfaces thereof, capable of enabling a micro control unit (MCU) to acquire a keyboard indication command while defining the keyboard indication command as an activating signal for controlling the on/off of a computer peripheral.

To achieve the above object, the present invention provides a control apparatus for enabling computer peripherals to be controlled by keyboard indication commands, being substantially a control box connected to a computer and a keyboard respectively by interfaces thereof, which is comprised of:
a micro control unit (MCU), capable of issuing an activating signal while receiving a keyboard indication command from the keyboard; and
a computer peripheral, capable of being activated/deactivated by the activating signal.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a functional block diagram of a control apparatus for enabling computer peripherals to be controlled by keyboard indication commands according to a first preferred embodiment of the invention.

FIG. 2 shows an application of FIG. 1.

FIG. 3 is a functional block diagram of a control apparatus for enabling computer peripherals to be controlled by keyboard indication commands according to a second preferred embodiment of the invention.

FIG. 4 shows an application of FIG. 3.

FIG. 5 is a schematic frame showing an application program being initiated by a mouse while using the application program to activate a computer peripheral.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

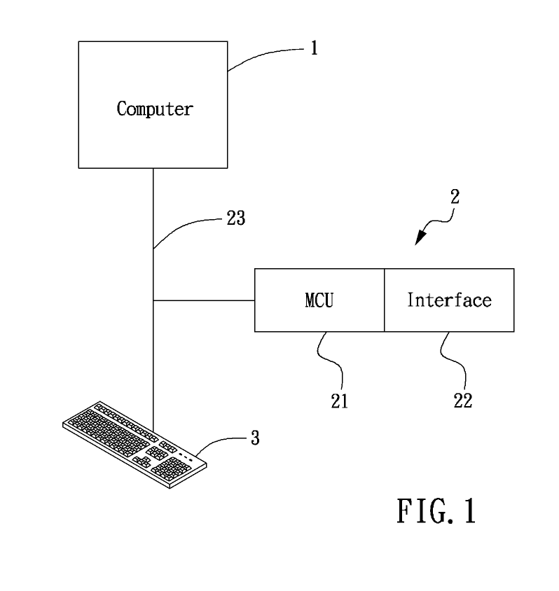

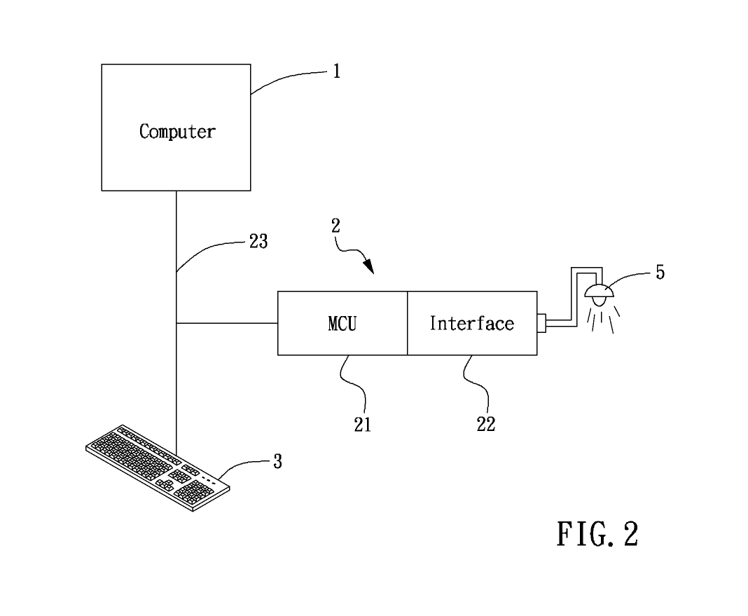

Please refer to FIG. 1, which is a functional block diagram of a control apparatus for enabling computer peripherals to be controlled by keyboard indication commands according to a first preferred embodiment of the invention. As seen in FIG. 1, the control apparatus, being substantially a control box 2 connected to a computer 1 and a keyboard 3 respectively by interfaces thereof, which is capable of enabling a micro control unit (MCU) 21 to acquire a keyboard indication command 23 while issuing the keyboard indication command 23 to a computer peripheral, such as the small luminaire 5 shown in FIG. 2, as an activating signal for controlling the on/off of a computer peripheral. Furthermore, an interface 23 is disposed in the control box 2 for enabling the electrical connection between the computer peripheral and the MCU 21. However, it is known to those skilled in the art that the electrical connection between the computer peripheral and the MCU 21 can be achieved directly without the interface 22. In general, keyboard indication command 23 can be defined by the lighting of three indication lights of Caps Lock, Num Lock and Scroll Lock. In a preferred aspect, the format of the keyboard indication command 23 is define as “ED xx”, whereas the character “ED” stands for a keyboard indication command and the two numerals “xx” stands for the lighting conditions of the three indication lights. For example, “ED 01” stands for the lighting of the Scroll Lock indication light, and “ED 05” stands for the lighting of the Scroll Lock and the Caps Lock simultaneously, and “ED 00” stands for the extinguishing of all the three indication lights.

In a preferred embodiment, the MCU 21 can be built in a control unit of the keyboard, such that not only the manufacturing cost can be reduced, but also it is more ease to implement since there is no need for the installation of an additional external control box 2.

In FIG. 2, as the on/off of the computer peripheral connected to the control apparatus 2 can be controlled by the aforesaid keyboard indication command, not only the size of such computer peripheral can be miniaturized, but also the structure thereof can be simplified as well as the cost is reduce, since such computer peripheral no long require to be configured with an on/off switch therein.

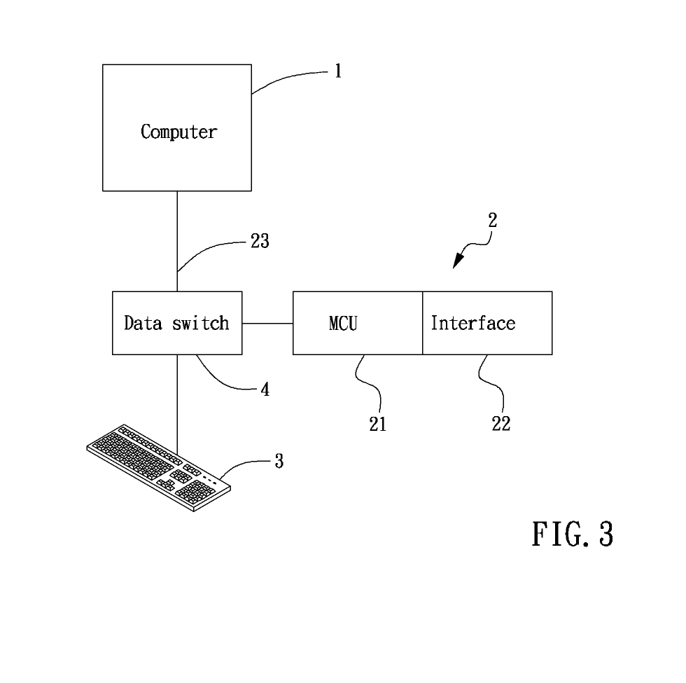

Please refer to FIG. 3, which is a functional block diagram of a control apparatus for enabling computer peripherals to be controlled by keyboard indication commands according to a second preferred embodiment of the invention. The difference between that of FIG. 2 and FIG. 1 is that: an additional data switch 4 is configured in the MCU 21 that is being used as a data buffer for enabling the MCU to deal with mass data flow. Therefore, the control apparatus of FIG. 2 is more structurally sounded than that of FIG. 1.

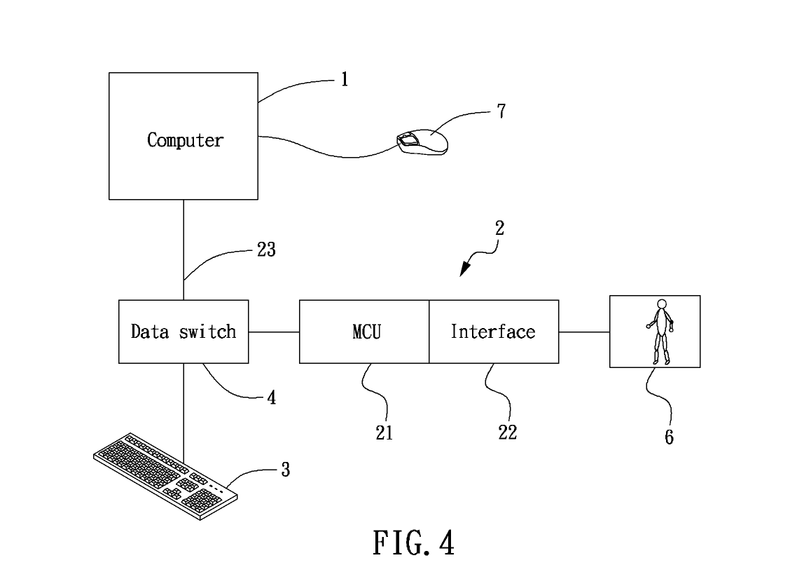

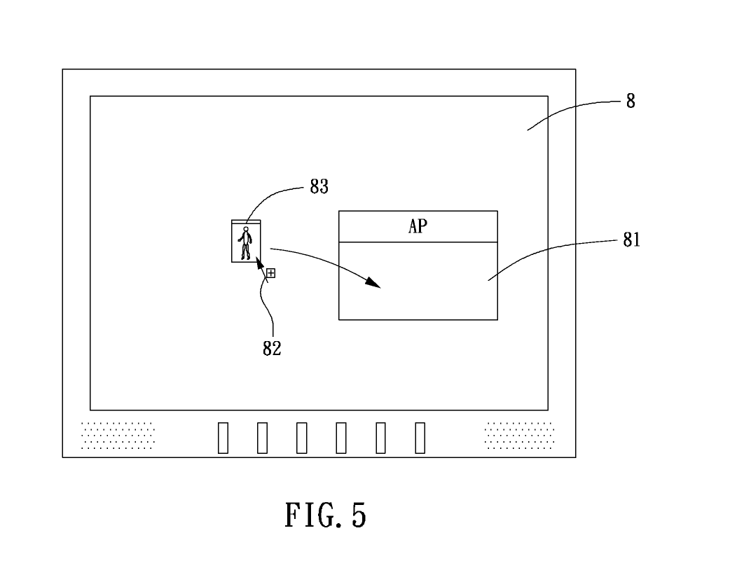

Please refer to FIG. 4 and FIG. 5, which respectively is an application of FIG. 2, and is a schematic frame showing an application program being initiated by a mouse while using the application program to activate a computer peripheral. In a computer screen 8 shown in FIG. 5, a mouse cursor 82 is specified to drag a frame 83 of jpeg format to a window 81 standing for an application program (AP), whereas the size of the frame 83 can be ranged from several KB to several MB that is considered as a mass data flow. As soon as the frame 83 is being dragged into the window 81, it is appearing on a small liquid crystal display 7 of the operation of the corresponding keyboard indication command and the control apparatus 2.

From the above description relating to FIGS. 1 to 5, it is noted that the present invention can provide a control apparatus for enabling computer peripherals to be controlled by keyboard indication commands, that enables a keyboard to be used not only as a device for inputting characters, numerals or symbols, but also as a control box, connected to a computer and a keyboard respectively by interfaces thereof, capable of enabling a micro control unit (MCU) to acquire a keyboard indication command while defining the keyboard indication command as an activating signal for controlling the on/off of a computer peripheral.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A control apparatus for enabling computer peripherals to be controlled by keyboard indication commands, being substantially a control box connected to a computer and a keyboard respectively by interfaces thereof, the control apparatus comprising:
a micro control unit (MCU), capable of issuing an activating signal while receiving a keyboard indication command from the keyboard; and
a computer peripheral, capable of being activated/deactivated by the activating signal.

2. The control apparatus of claim 1, further comprising:
an interface, for electrically connecting the MCU to the peripheral.

3. The control apparatus of claim 1, wherein the MCU is built in a control unit of the keyboard.

4. The control apparatus of claim 1, further comprising:
a data switch, for controlling the MCU to receive the keyboard indication command.

5. The control apparatus of claim 1, wherein the MCU is capable of actively issuing a command for controlling the keyboard.

6. The control apparatus of claim 1, wherein the computer peripheral is a signal switch.

7. The control apparatus of claim 1, wherein the computer peripheral is a small-sized luminaire.

8. The control apparatus of claim 1, wherein the computer peripheral is a small-sized fan.

9. The control apparatus of claim 1, wherein the computer peripheral is a small-sized liquid crystal display.
